(19) United States
(12) Patent Application Publication
(10) Pub. No.: US 2026/0094769 A1
(43) Pub. Date: Apr. 2, 2026

(54) MULTILAYER ELECTRONIC COMPONENT

(71) Applicant: SAMSUNG ELECTRO-MECHANICS CO., LTD., Suwon-si (KR)

(72) Inventors: Jun Il SONG, Suwon-si (KR); Chae Rim KIM, Suwon-si (KR); Sung Hyun CHO, Suwon-si (KR); Sung Hyung KANG, Suwon-si (KR)

(73) Assignee: SAMSUNG ELECTRO-MECHANICS CO., LTD., Suwon-si (KR)

(21) Appl. No.: 19/083,617

(22) Filed: Mar. 19, 2025

(30) Foreign Application Priority Data
Sep. 30, 2024 (KR) 10-2024-0132836

(51) Int. Cl. H01G 4/30; H01G 4/012; H01G 4/12

(52) U.S. Cl. CPC H01G 4/30; H01G 4/012; H01G 4/1227

(57) ABSTRACT

A multilayer electronic component includes a body having first and second surfaces opposing each other in a first direction, third and fourth surfaces connected to the first and second surfaces, the third and fourth surfaces opposing each other in a second direction, and fifth and sixth surfaces connected to the first to fourth surfaces, the fifth and sixth surfaces opposing each other in a third direction, the body including dielectric layers and internal electrodes disposed alternately with the dielectric layers in the first direction, and an external electrode disposed on the third or fourth surfaces. When a maximum size of the multilayer electronic component in the first direction is denoted by T, a maximum size of the multilayer electronic component in the second direction is denoted by L, and a maximum size of the multilayer electronic component in the third direction is denoted by W, W>L and 1.25≤T/L≤1.5 are satisfied.

### CROSS-REFERENCE TO RELATED APPLICATION(S)

This application claims benefit of priority to Korean Patent Application No. 10-2024-0132836 filed on Sep. 30, 2024 in the Korean Intellectual Property Office, the disclosure of which is incorporated herein by reference in its entirety.

### TECHNICAL FIELD

The present disclosure relates to a multilayer electronic component.

A multilayer ceramic capacitor (MLCC), a multilayer electronic component, is a chip-type condenser mounted on the printed circuit boards of various types of electronic products such as imaging devices, including a liquid crystal display (LCD) and a plasma display panel (PDP), computers, smartphones, and mobile phones, and serves to charge or discharge electricity therein or therefrom. A multilayer ceramic capacitor may be used as a component of various electronic devices due to having a small size, ensuring high capacitance and being easily mounted.

Recently, with the expansion of the automobile market, high-temperature and high-pressure MLCCs having an operating voltage of 250 V or higher have been increasingly used in circuits such as automobile high-voltage battery chargers (OBCs) and DC/DC converters. In the above-described level of high-temperature and high-pressure environments, the heat generation of MLCCs may be aggravated. Such a heat generation phenomenon may accelerate the dielectric loss of MLCCs, thereby reducing the reliability of MLCCs. Accordingly, there is a need for improvement in the heat dissipation of MLCCs.

### SUMMARY

An aspect of the present disclosure provides a multilayer electronic component having excellent reliability.

However, the aspects of the present disclosure are not limited to those set forth herein, and will be more easily understood in the course of describing specific example embodiments of the present disclosure.

According to an aspect of the present disclosure, there is provided a multilayer electronic component including a body having first and second surfaces opposing each other in a first direction, third and fourth surfaces connected to the first and second surfaces, the third and fourth surfaces opposing each other in a second direction, and fifth and sixth surfaces connected to the first to fourth surfaces, the fifth and sixth surfaces opposing each other in a third direction, the body including a plurality of dielectric layers and a plurality of internal electrodes disposed alternately in the first direction, and an external electrode disposed on the third or fourth surfaces. When a maximum size of the multilayer electronic component in the first direction is denoted by T, a maximum size of the multilayer electronic component in the second direction is denoted by L, and a maximum size of the multilayer electronic component in the third direction is denoted by W, W>L and 1.25≤T/L≤1.5 may be satisfied.

According to example embodiments of the present disclosure, a multilayer electronic component may have excellent reliability.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is a schematic perspective view of a multilayer electronic component according to an example embodiment of the present disclosure;

FIG. 2 is a schematic cross-sectional view of FIG. 1, taken along line I-I′;

FIG. 3 is a schematic cross-sectional view of FIG. 1, taken along line II-II′;

FIG. 4 is a schematic cross-sectional view of FIG. 2, taken along line III-III′; and

FIGS. 5 to 7 are schematic cross-sectional views of multilayer electronic components according to other example embodiments of the present disclosure, each view corresponding to FIG. 2.

### DETAILED DESCRIPTION

Hereinafter, example embodiments of the present disclosure are described with reference to the accompanying drawings. The present disclosure may, however, be exemplified in many different forms and should not be construed as being limited to the specific example embodiments set forth herein. In addition, example embodiments of the present disclosure may be provided for a more complete description of the present disclosure to those skilled in the art. Accordingly, the shapes and sizes of the elements in the drawings may be exaggerated for clarity of description, and elements denoted by the same reference numerals in the drawings may be the same elements.

In order to clearly illustrate the present disclosure, portions not related to the description are omitted, and sizes and thicknesses are magnified in order to clearly represent layers and regions, and similar portions having the same functions within the same scope are denoted by similar reference numerals throughout the specification. Throughout the specification, when an element is referred to as “comprising” or “including,” it means that it may include other elements as well, rather than excluding other elements, unless specifically stated otherwise.

In the drawings, a first direction (D1) may be defined as a thickness direction, a second direction (D2) may be defined as a length direction, and a third direction (D3) may be defined as a width direction.

### Multilayer Electronic Component

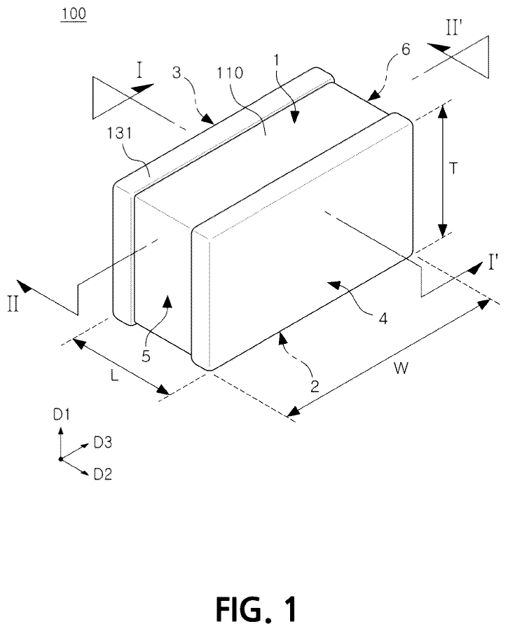

FIG. 1 is a schematic perspective view of a multilayer electronic component according to an example embodiment of the present disclosure.

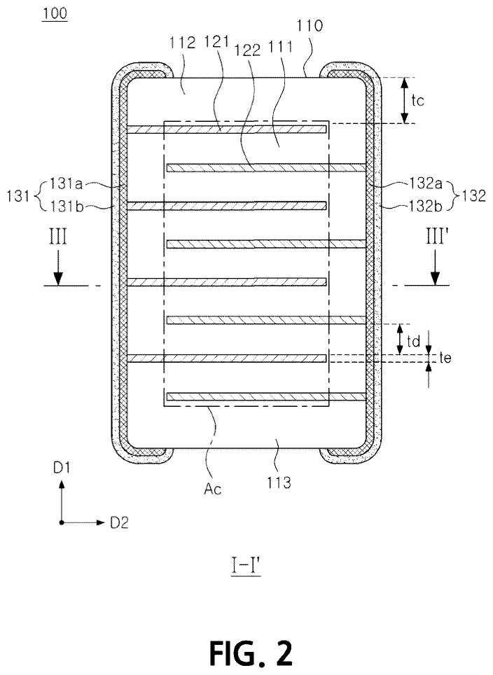

FIG. 2 is a schematic cross-sectional view of FIG. 1, taken along line I-I′.

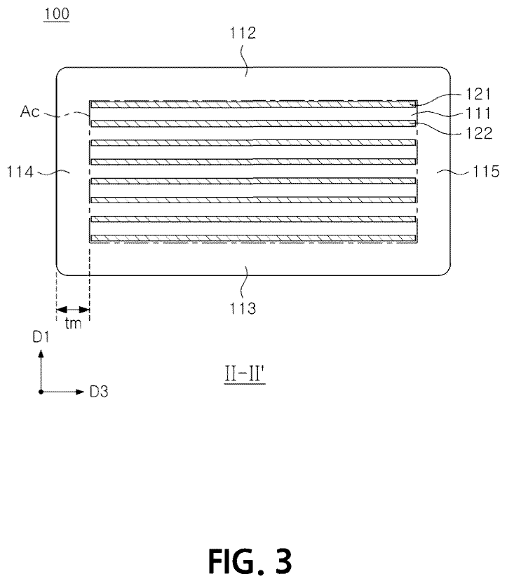

FIG. 3 is a schematic cross-sectional view of FIG. 1, taken along line II-II′.

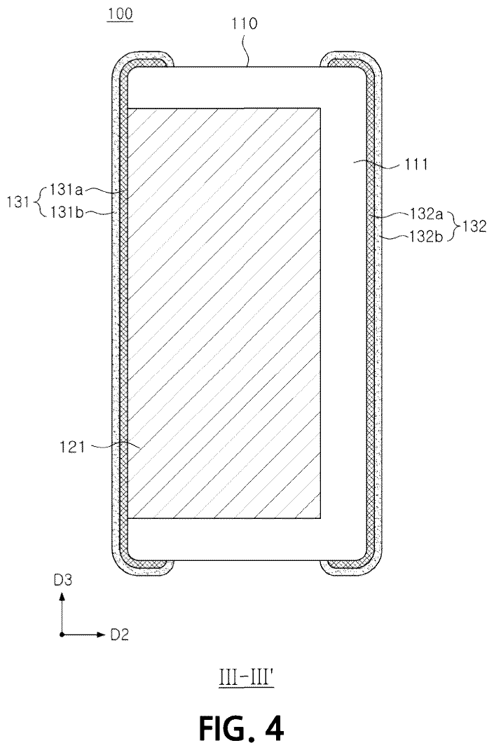

FIG. 4 is a schematic cross-sectional view of FIG. 2, taken along line III-III′.

Hereinafter, a multilayer electronic component 100 according to an example embodiment of the present disclosure will be described in detail with reference to FIGS. 1 to 4. A multilayer ceramic capacitor is described as an example of a multilayer electronic component, but the present disclosure is not limited thereto, and may be applied to various electronic products using a dielectric composition, such as inductors, piezoelectric elements, varistors, thermistors, or the like.

The multilayer electronic component 100 may include a body 110 and external electrodes 131 and 132.

A specific shape of the body 110 is not limited. However, the body 110 may have a hexahedral shape or a shape similar thereto. Due to the contraction of ceramic powder particles included in the body 110 during a sintering process or a process of polishing an edge portion of the body 110 after the sintering process, the body 110 may not have a hexahedral shape having perfectly straight lines, but may have a substantially hexahedral shape.

The body 110 may have first and second surfaces 1 and 2 opposing each other in a first direction, third and fourth surfaces 3 and 4 connected to the first and second surfaces 1 and 2, the third and fourth surfaces 3 and 4 opposing each other in a second direction, and fifth and sixth surfaces 5 and 6 connected to the first to fourth surfaces 1, 2, 3, and 4, the fifth and sixth surfaces 5 and 6 opposing each other in a third direction.

The body 110 may include a plurality of dielectric layers 111 and internal electrodes 121 and 122 alternately disposed with the dielectric layers 111 in the first direction. A plurality of dielectric layers 111, included in the body 110, may be in a sintered state, and adjacent dielectric layers 111 may be integrated with each other such that boundaries therebetween are not readily apparent without using a scanning electron microscope (SEM).

The dielectric layer 111 may include, for example, a perovskite-type compound, denoted by ABO₃, as a main component. The perovskite-type compound, denoted by ABO₃, may include, for example, (Ca₁₋ₓSrₓ)(Zr_{1-y}Ti_{y})O₃ (0≤x≤0.5, 0≤y≤0.5), BaTiO₃, (Ba₁₋ₓCaₓ)TiO₃ (0<x<1), Ba(Ti_{1-y}Ca_{y})O₃ (0<y<1), (Ba₁₋ₓCaₓ)(Ti_{1-y}Zr_{y})O₃ (0<x<1, 0<y<1), or Ba(Ti_{1-y}Zr_{y})O₃ (0<y<1).

However, when a ferroelectric such as BaTiO₃ is used as the perovskite-type compound included in the dielectric layer 111, the dielectric layer 111 may have a high dielectric constant at room temperature, but the dielectric constant may be reduced in a high-temperature and high-pressure environment.

Conversely, a CaZrO₃-based perovskite compound that is a paraelectric may have a small dielectric constant temperature change and a small dielectric loss. That is, in the multilayer electronic component 100 used in a high-temperature and high-pressure environment, the dielectric layer 111 may preferably include (Ca₁₋ₓSrₓ)(Zr_{1-y}Ti_{y})O₃ (0≤x≤0.5, 0≤y≤0.5) so as to lower a capacitance temperature change rate.

The internal electrodes 121 and 122 may include a first internal electrode 121 and a second internal electrode 122 alternately disposed in the first direction with the dielectric layer 111 interposed therebetween. The first internal electrode 121 and the second internal electrode 122 may be electrically isolated from each other by the dielectric layer 111 interposed therebetween.

The first internal electrode 121 may be spaced apart from the fourth surface 4, and may be exposed to the third surface 3. The first internal electrode 121 may be electrically connected to the first external electrode 131 disposed on the third surface 3. The second internal electrode 122 may be spaced apart from the third surface 3, and may be exposed to the fourth surface 4. The second internal electrode 122 may be electrically connected to the second external electrode 132 disposed on the fourth surface 4.

A conductive metal, included in the internal electrodes 121 and 122, may include one or more of Ni, Cu, Al, Pd, Ag, In, Sn, Ti, and alloys thereof, and may preferably include Ni, but the present disclosure is not limited thereto.

The body 110 may include a capacitance formation portion Ac disposed in the body 110, the capacitance formation portion Ac in which the first and second internal electrodes 121 and 122 are alternately disposed with the dielectric layer 111 interposed therebetween to form capacitance, and cover portions 112 and 113 disposed on both surfaces of the capacitance formation portion Ac opposing each other in the first direction. The cover portions 112 and 113 may have a configuration similar to that of the dielectric layer 111, except that the internal electrodes are not included.

The body 110 may include margin portions 114 and 115 disposed on both surfaces of the capacitance formation portion Ac opposing each other in the third direction. The margin portions 114 and 115 may refer to regions between both ends of the internal electrodes 121 and 122 and a boundary surface of the body 110 in a cross-section of the body 110 in the first and third directions. The margin portions 114 and 115 may have a configuration similar to that of the dielectric layer 111, except that the internal electrodes 121 and 122 are not included.

The cover portions 112 and 113 and the margin portions 114 and 115 may basically serve to prevent damage to the internal electrodes 121 and 122 due to physical or chemical stress.

The external electrodes 131 and 132 may be disposed on the third and fourth surfaces 3 and 4 of the body 110, respectively. The multilayer electronic component 100 may include a first external electrode 131 disposed on the third surface 3, and a second external electrode 132 disposed on the fourth surface 4. The first external electrode 131 may be disposed on the third surface 3 and extend onto portions of the first, second, fifth and sixth surfaces 1, 2, 5 and 6, and the second external electrode 132 may be disposed on the fourth surface 4 and extend onto portions of the first, second, fifth and sixth surfaces 1, 2, 5, and 6.

A type or shape of the external electrodes 131 and 132 is not limited, and may have a multilayer structure. For example, the external electrodes 131 and 132 may include base electrode layers 131a and 132a in contact with the internal electrodes 121 and 122, and plating layers 131b and 132b disposed on the base electrode layers 131a and 132a.

The base electrode layers 131a and 132a may be sintered electrode layers including a metal and glass. The metal, included in the base electrode layers 131a and 132a, may include, for example, Cu, Ni, Sn, Al, Pd, Ag, and/or an alloy including the same. The glass, included in the base electrode layers 131a and 132a, may include, for example, one or more oxides of Ba, Ca, Zn, Al, B, and Si.

The base electrode layers 131a and 132a may include only a sintered electrode layer including a metal and glass, but the present disclosure is not limited thereto. The base electrode layers 131a and 132a may include, for example, a sintered electrode layer including a metal and glass, and a resin electrode layer disposed on the sintered electrode layer, the resin electrode layer including metal particles and a resin.

The metal particles, included in the resin electrode layer, may include one or more of spherical particles and flake-type particles. Here, the spherical particles may have a shape that is not completely spherical, for example, a shape in which a length ratio (long axis/short axis) between a long axis and a short axis is 1.45 or less. The flake-type particles may refer to particles having a flat and elongated shape, but the present disclosure is not limited thereto. The metal, included in the resin electrode layer, may include, for example, Cu, Ni, Pd, Ag, Pb, Sn and/or an alloy including the same. The resin, included in the resin electrode layer, may include, for example, one or more of an epoxy resin, an acrylic resin, and ethyl cellulose.

The plating layers 131b and 132b may include, for example, Ni, Sn, Pd, and/or an alloy including the same, and may be formed of a plurality of layers. The plating layers 131b and 132b may be, for example, a Ni plating layer or an Sn plating layer, and may have a form in which the Ni plating layer and the Sn plating layer are sequentially formed. In addition, the plating layers 131b and 132b may include a plurality of Ni plating layers and/or a plurality of Sn plating layers.

In the drawings, a structure is illustrated in which the multilayer electronic component 100 has two external electrodes 131 and 132, but the present disclosure is not limited thereto, and the number or shapes of the external electrodes 131 and 132 may be changed depending on shapes of the internal electrodes 121 and 122 or other purposes.

In general, a maximum size (L) of the multilayer electronic component in the second direction may be greater than a maximum size (T) of the multilayer electronic component in the first direction and a maximum size (W) of the multilayer electronic component in the third direction. That is, in general, the multilayer electronic component may satisfy L>T and L>W. In this case, the internal electrode may be exposed to a surface (hereinafter, referred to as a WT surface) of the body in the first direction×the third direction having an area, relatively narrower than an area of a surface (hereinafter, referred to as an LT surface) of the body in the first direction×the second direction.

However, heat generated in the multilayer electronic component may be mainly discharged to the outside of the multilayer electronic component through the internal electrode and the external electrode mainly including a metal having thermal conductivity higher than that of ceramics. Thus, in a structure according to the related art, heat may be discharged to the WT surface of the body having a relatively narrow area.

According to an example embodiment of the present disclosure, when a maximum size of the multilayer electronic component 100 in the first direction is T, a maximum size of the multilayer electronic component 100 in the second direction is L, and a maximum size of the multilayer electronic component 100 in the third direction is W, W>L may be satisfied. Accordingly, the internal electrodes 121 and 122 may be exposed to the WT surface of the body 110 having an area, relatively wider than that of the LT surface of the body 110. Accordingly, heat generated in the multilayer electronic component 100 may be effectively discharged.

In order to effectively discharge heat generated in the multilayer electronic component 100 by sufficiently securing the exposed area of each of the internal electrodes 121 and 122, a ratio of a maximum size of the internal electrodes 121 and 122 in the third direction to W may be, for example, 0.7 or more and 0.9 or less

In addition, in order to implement the intended electrical characteristics of the multilayer electronic component 100 within a limited mounting area, T and L may need to be properly designed. When T excessively increases, the number of laminated internal electrodes 121 and 122 may increase accordingly, and thus cracks or delamination may occur in the multilayer electronic component 100. In addition, when L excessively increases, sizes of the internal electrodes 121 and 122 in the second direction increases accordingly, and thus ESL and ESR of the multilayer electronic component 100 may increase.

Accordingly, the present inventors confirmed that heat dissipation characteristics, ESL/ESR characteristics, and reliability of the multilayer electronic component 100 are improved when T and L satisfy 1.25≤T/L≤1.5. When T/L is less than 1.25, the multilayer electronic component 100 may have degraded high-temperature reliability. When T/L is greater than 1.5, cracks may occur in the multilayer electronic component 100. T and L may preferably satisfy 1.3≤T/L≤1.4 in consideration of ease of mounting or the like.

A ratio (L/W) of L to W is not limited. However, L and W may satisfy L/W≤0.8. When L/W≤0.8 is satisfied, heat dissipation characteristics may be more remarkably improved.

In addition, T, L, and W may have various values according to a standard of the multilayer electronic component 100. However, heat dissipation characteristics in a high-temperature and high-pressure environment may become more important as a size of the multilayer electronic component 100 increases. In particular, when L and W satisfy L≥2.5 mm and W≥3.2 mm, heat dissipation characteristics may be more remarkably improved.

In addition, a capacitance of the multilayer electronic component 100 may be determined according to the standard of the multilayer electronic component 100, heat dissipation characteristics in a high-temperature and high-pressure environment may become more important as the capacitance of the multilayer electronic component 100 increases. In particular, when the multilayer electronic component 100 satisfies COG characteristics and has a capacitance of 10 nF or more, heat dissipation characteristics may be more remarkably improved. In addition, when the rated voltage of the multilayer electronic component 100 is 630 V or more, heat dissipation characteristics may be more remarkably improved.

An average thickness (the) of the internal electrodes 121 and 122 is not limited. However, when the average thickness (the) of the internal electrodes 121 and 122 is 1.0 μm or more, the exposed area of the internal electrodes 121 and 122 may be sufficiently secured to improve heat dissipation characteristics of the multilayer electronic component 100. An upper limit of the average thickness (the) of the internal electrodes 121 and 122 is not limited, but may be, for example, 2.0 μm or less.

An average thickness (td) of the dielectric layer 111 is not limited, but may be, for example, 1.0 μm to 50.0 μm. In an example embodiment, the average thickness (td) of the dielectric layer 111 may be greater than twice the average thickness of the internal electrodes 121 and 122. That is, td>2×te may be satisfied. When td>2×te is satisfied, a decrease in an insulation breakdown voltage of the multilayer electronic component 100 under a high-voltage environment may be suppressed.

The average thickness (td) of the dielectric layer 111 and the average thickness (the) of the internal electrodes 121 and 122 may respectively refer to a size of the dielectric layer 111 in the first direction, and a size of the internal electrodes 121 and 122 in the first direction. The average thickness (td) of the dielectric layer 111 and the average size (the) of the internal electrodes 121 and 122 may be measured, for example, by scanning, with an SEM, a cross-section of the body 110 in the first and second directions at a magnification of 10,000. More specifically, the average thickness (td) of the dielectric layer 111 may be measured by measuring thicknesses of a single dielectric layer 111 at multiple points of the dielectric layer 111, for example, thirty points equally spaced apart from each other in the second direction, and calculating an average value of the thicknesses. In addition, the average thickness (the) of the internal electrodes 121 and 122 may be measured by measuring thicknesses of the internal electrodes 121 and 122 at multiple points of the internal electrodes 121 and 122, for example, thirty points equally spaced apart from each other in the second direction, and calculating an average value of the thicknesses. The thirty points, equally spaced apart from each other, may be designated in the capacitance formation portion Ac. When such average value measurement is performed on ten dielectric layers 111 and ten internal electrodes 121 and 122, the average thickness of the dielectric layer 111 and the average thickness of the internal electrodes 121 and 122 may be further generalized.

An average thickness (tc) of the cover portions 112 and 113 is not limited. The average thickness (tc) of the cover portions 112 and 113 may be, for example, 300 μm or less, 200 μm or less, 150 μm or less, or 50 μm or less. The average thickness (tc) of the cover portions 112 and 113 may be, for example, 5 μm or more, 10 μm or more, or 30 μm or more. Here, the average thickness (tc) of the cover portions 112 and 113 means an average thickness of each of the first cover portion 112 and the second cover portion 113.

The average thickness (tc) of the cover portions 112 and 113 may refer to an average size of the cover portions 112 and 113 in the first direction, and may be an average value obtained by averaging sizes of the cover portions 112 and 113 in the first direction, measured at five equally spaced points in a cross-section of the body 110 in the first and second directions.

An average thickness (tm) of the margin portions 114 and 115 is not limited. The average thickness (tm) of the margin portions 114 and 115 may be, for example, 150 μm or less, 100 μm or less, 20 μm or less, or 15 μm or less. The average thickness (tm) of the margin portions 114 and 115 may be, for example, 5 μm or more, 10 μm or more, or 30 μm or more. Here, the average thickness (tm) of the margin portions 114 and 115 may refer to an average thickness of each of the first and second margin portions 114 and 115.

An average thickness (tm) of each of the margin portions 114 and 115 may refer to an average size of the margin portions 114 and 115 in the third direction, and may be an average value obtained by averaging sizes of the margin portions 114 and 115 in the third direction, measured at five equally spaced points in a cross-section of the body 110 in the first and third directions.

Hereinafter, an example of a method of forming a multilayer electronic component 100 will be described.

First, ceramic powder particles for forming a dielectric layer 111 may be prepared. The ceramic powder particles may be, for example (Ca₁₋ₓSrₓ)(Zr_{1-y}Ti_{y})O₃ (0≤x≤0.5, 0≤y≤0.5). A method of synthesizing the ceramic powder particles may include, for example, a solid-phase method, a sol-gel method, and a hydrothermal synthesis method, but the present disclosure is not limited thereto. Subsequently, the prepared ceramic powder particles may be dried and ground, an organic solvent such as ethanol, a binder such as polyvinyl butyral, and other auxiliary ingredients may be mixed to prepare a ceramic slurry, and then the ceramic slurry may be coated and dried on a carrier film to prepare a ceramic green sheet.

Subsequently, an internal electrode pattern may be formed by printing a conductive paste for an internal electrode, including metal powder particles, a binder, an organic solvent, or the like, to a predetermined thickness on the ceramic green sheet using a screen-printing method or gravure-printing method.

Thereafter, the ceramic green sheet on which the internal electrode pattern is printed may be peeled off from the carrier film, and then may be laminated to correspond to a predetermined number of layers and then compressed to form a ceramic laminate. In order to form cover portions 112 and 113 on which sintering has been performed, a ceramic green sheet having no internal electrode pattern may be laminated on upper and lower portions of the ceramic laminate on which sintering has not been performed to correspond to a predetermined number of layers. Thereafter, the ceramic laminate may be cut to have a predetermined chip size, and a cut chip may be sintered at a temperature of 1000° C. or higher and 1400° C. or lower to form a body 110.

Subsequently, external electrodes 131 and 132 may be formed. The body 110 may be dipped in a conductive paste including metal powder particles, a glass frit, a binder, and an organic solvent, and then the conductive paste may be sintered at a temperature of 500° C. to 900° C. to form base electrode layers 131a and 132a. When the base electrode layers 131a and 132a have a form in which a sintered electrode layer and a resin electrode layer are sequentially laminated, the second layer may be formed on the first layer by coating a conductive resin composition including metal powder particles, a resin, a binder, and an organic solvent on the sintered electrode layer, and then performing curing heat treatment at a temperature of 250° C. to 550° C.

The plating layers 131b and 132b may be formed using, for example, an electroplating method and/or an electroless plating method.

### EXAMPLES

Sample chips of sample numbers 1 to 6 were prepared to evaluate heat dissipation characteristics, ESL, highly accelerated life test (HALT) reliability, and crack frequency of a multilayer electronic component according to a relationship between T, L and W. A sample chip of sample number 1 was manufactured to have a size of 3225 (length: about 3.2±0.3 mm, width: about 2.5±0.3 mm, thickness: about 2.5±0.3 mm).

Heat generation evaluation was conducted with respect to a sample chip of each sample number. First, a sample chip of sample number 1 was disposed on a hot plate at 105° C. Subsequently, a rated voltage was applied to the sample chip under a condition of 70 kHz using an amplifier. While the sample chip was observed with a thermal imaging camera, an AC voltage applied to the sample chip was measured with an IV analyzer until a temperature of the hot plate reached 125° C. When a value of an AC voltage applied to the sample chip of sample number 1 is 100%, values of AC voltages applied to sample chips of sample numbers 2 to 6 were evaluated and indicated in Table 1 below.

In addition, ESL evaluation was conducted. An AC signal was measured in a sweep mode in a frequency range of 100 kHz to 3 GHz using an impedance analyzer (E4990A, E4991B). ESL was calculated as an average of inductance values from self-resonance frequency (SRF) to END frequency. ESL values of sample chips of sample numbers 2 to 6 were evaluated when an ESL value measured in a sample chip of sample number 1 was 100%, and indicated in Table 1 below.

In addition, HALT was conducted. With respect to 400 sample chips of each of sample numbers 1 to 6, HALT was conducted for 24 hours under conditions of 125° C. and 1.2 Vr. When a sample chip had an insulation resistance decreased to 10⁴Ω or less or a short-circuit due to being burnt, it was determined that the sample chip was defective.

In addition, crack frequency evaluation was conducted. Cross-sections of 100 sample chips of each of sample numbers 1 to 6 were analyzed with an optical microscope. In this case, the number of sample chips having cracks or delamination was measured and indicated in Table 1 below.

TABLE 1

| Sample | | | | Heat generation | | | |
|---|---|---|---|---|---|---|---|
| number | T/L | T/W | L/W | evaluation | ESL | HALT | Crack |
| 1 | 0.8 | 1 | 1.25 | 100% | 100% | 20/400 | 0/100 |
| 2 | 0.9 | 0.72 | 0.8 | 100% | 80% | 40/400 | 0/100 |
| 3 | 1.2 | 0.96 | 0.8 | 100% | 80% | 0/400 | 0/100 |
| 4 | 1.25 | 1 | 0.8 | 105% | 80% | 0/400 | 0/100 |
| 5 | 1.5 | 1.2 | 0.8 | 110% | 80% | 0/400 | 0/100 |
| 6 | 1.7 | 1.36 | 0.8 | 115% | 80% | 0/400 | 2/100 |
| 7 | 1.25 | 1.25 | 1 | 100% | 80% | 0/400 | 0/100 |

Referring to Table 1, it can be seen that, in sample numbers 2 and 3 having a T/L of less than 1.25, heat dissipation characteristics were not improved as compared to sample number 1, and in sample number 2, a high-temperature lifespan was degraded as compared to sample number 1. In addition, it can be seen that, in sample number 6 having a T/L of greater than 1.5, cracks occurred due to an increase in the number of laminates of internal electrodes.

Conversely, in sample numbers 4 and 5 having T/L satisfying 1.25 or more and 1.5 or less, it can be seen that crack defects did not occur even when heat dissipation characteristics, ESL characteristics, and high-temperature lifespan characteristics were all improved as compared to sample number 1. As a result, when T/L satisfies 1.25 or more and 1.5 or less, it can be seen that a multilayer electronic component had improved reliability.

In particular, it can be seen that, in sample number 7 having T/L of 1.25 and L/W of greater than 0.8, ESL characteristics were improved as compared to sample number 1, but heat dissipation characteristics were not improved. Accordingly, when T/L satisfies 1.25 or more and 1.5 or less, and W is greater than L, or more preferably L/W is 0.8 or less, it can be seen that heat dissipation characteristics were more remarkably improved.

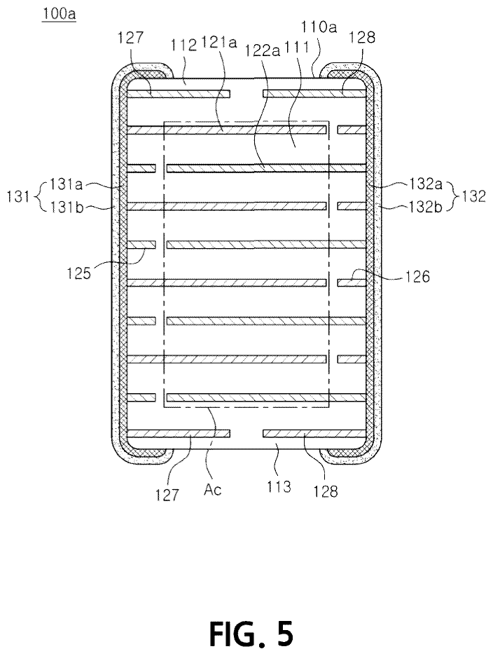

FIGS. 5 to 7 are schematic cross-sectional views of multilayer electronic components according to other example embodiments of the present disclosure, each view corresponding to FIG. 2.

Hereinafter, multilayer electronic components 100a, 100b, and 100c according to other example embodiments of the present disclosure will be described with reference to FIGS. 5 to 7. Components the same as or similar to the components of the multilayer electronic component 100 described in FIGS. 1 to 4 are used by the same/similar reference numerals, and repeated descriptions thereof will be omitted.

Referring to FIG. 5, a first internal electrode 121a exposed to a third surface and a second internal electrode 122a exposed to a fourth surface may be included. The first internal electrode 121a and the second internal electrode 122a may be alternately disposed with a dielectric layer 111 interposed therebetween.

A body 110a of the multilayer electronic component 100a may include a first dummy electrode 125 spaced apart from the second internal electrode 122a in a second direction and exposed to the third surface, and a second dummy electrode 126 spaced apart from the first internal electrode 121a in the second direction and exposed to the fourth surface.

Dummy electrodes 125 and 126 may not contribute to forming capacitance of the multilayer electronic component 100a, but may be exposed to the third and fourth surfaces, thereby contributing to improvement in heat dissipation characteristics of the multilayer electronic component 100a.

The body 110a may include a first shield layer 127 disposed on cover portions 112 and 113 and exposed to the third surface, and a second shield layer 128 disposed on the cover portions 112 and 113 and exposed to the fourth surface. The shield layers 127 and 128 may be disposed on each of the first cover portion 112 and the second cover portion 113. The shield layers 127 and 128 may serve to prevent arc discharge of the multilayer electronic component 100a.

In the drawings, it is illustrated that one first shield layer 127 and one second shield layer 128 are disposed on each of the cover portions 112 and 113, but the present disclosure is not limited thereto, and a plurality of first shield layers 127 and a plurality of second shield layers 128 may be disposed on each of the cover portions 112 and 113. For example, the shield layers 127 and 128 may include a material, the same as that of the internal electrodes 121 and 122.

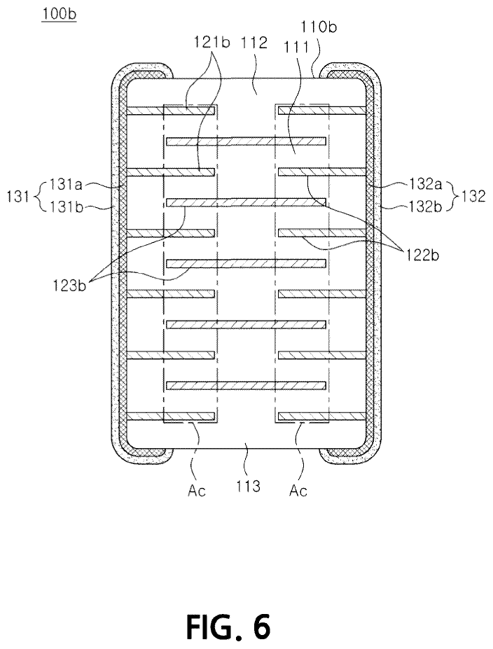

Referring to FIG. 6, internal electrodes 121b, 122b and 123b may include a first internal electrode 121b, a second internal electrode 122b, and a third internal electrode 123b. For example, the internal electrodes 121b, 122b and 123b may include a first internal electrode group and a second internal electrode group alternately disposed with a dielectric layer 111 interposed therebetween.

The first internal electrode group may include a first internal electrode 121b exposed to a third surface, and a second internal electrode 122b spaced apart from the first internal electrode 121b in a second direction and exposed to a fourth surface. The second internal electrode group may include a third internal electrode 123b spaced apart from the third and fourth surfaces.

The third internal electrode 123b may overlap a portion of the first internal electrode 121b and a portion of the second internal electrode 122b in a first direction. That is, a body 110b may include the third internal electrode 123b, a floating electrode not exposed to one of the third and fourth surfaces, and thus may have a structure in which a capacitance formation portion Ac is divided into two portions.

A multilayer electronic component 100b may increase the number of the first and second internal electrodes 121b and 122b exposed to the third and fourth surfaces through the floating electrode, thereby improving heat dissipation characteristics of the multilayer electronic component 100b.

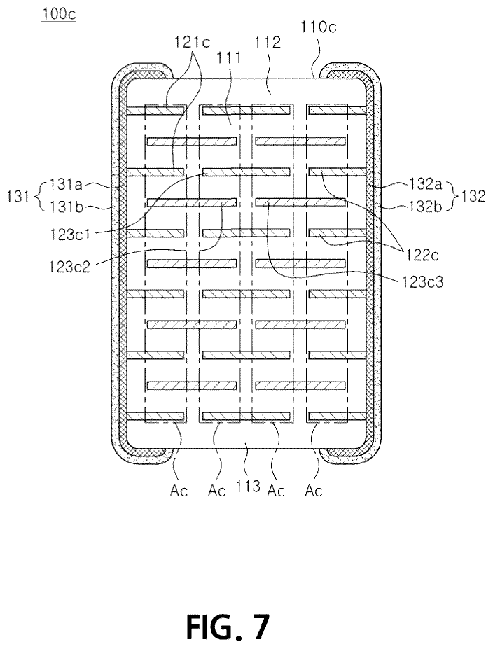

Referring to FIG. 7, internal electrodes 121c, 122c, 123c1, 123c2, and 123c3 may include a first internal electrode 121c, a second internal electrode 122c, a third internal electrode 123c1, a fourth internal electrode 123c2, and a fifth internal electrode 123c3. For example, the internal electrodes 121c, 122c, 123c1, 123c2, and 123c3 may include a first internal electrode group and a second internal electrode group alternately disposed with a dielectric layer 111 interposed therebetween.

The first internal electrode group may include a first internal electrode 121c exposed to a third surface, a second internal electrode 122c spaced apart from the first internal electrode 121c in a second direction and exposed to a fourth surface, and a third internal electrode 121c1 disposed between the first and second internal electrodes 121c and 122c.

The second internal electrode group may include fourth and fifth internal electrodes 123c2 and 123c3 spaced apart from the third and fourth surfaces, the fourth and fifth internal electrodes 123c2 and 123c3 spaced apart from each other in the second direction.

The fourth internal electrode 123c2 may overlap a portion of the first internal electrode 121c and a portion of the third internal electrode 121cl in a first direction, and the fifth internal electrode 123c3 may overlap a portion of the second internal electrode 122c and a portion of the third internal electrode 123cl in the first direction. That is, the body 110c may include the third to fifth internal electrodes 123c1, 123c2, and 123c3, floating electrodes not exposed to one of the third and fourth surfaces, and thus may have a structure in which a capacitance formation portion Ac is divided into four portions.

A multilayer electronic component 100c may increase the number of the first and second internal electrodes 121c and 122c exposed to the third and fourth surfaces through the floating electrodes, thereby improving heat dissipation characteristics of the multilayer electronic component 100c.

While example embodiments have been illustrated and described above, it will be apparent to those skilled in the art that modifications and variations could be made without departing from the scope of the present disclosure as defined by the appended claims.

In addition, the term “an example embodiment” used herein does not refer to the same example embodiment, and is provided to emphasize a particular feature or characteristic different from that of another example embodiment. However, example embodiments provided herein are considered to be able to be implemented by being combined in whole or in part one with one another. For example, one element described in a particular example embodiment, even if it is not described in another example embodiment, may be understood as a description related to another example embodiment, unless an opposite or contradictory description is provided therein.

As used herein, the terms “first,” “second,” and the like may be used to distinguish a component from another component, and may not limit a sequence and/or an importance, or others, in relation to the components. In some cases, a first component may be referred to as a second component, and similarly, a second component may be referred to as a first component without departing from the scope of the example embodiments.

What is claimed is:

1. A multilayer electronic component comprising:
a body having first and second surfaces opposing each other in a first direction, third and fourth surfaces connected to the first and second surfaces, the third and fourth surfaces opposing each other in a second direction, and fifth and sixth surfaces connected to the first to fourth surfaces, the fifth and sixth surfaces opposing each other in a third direction, the body including a plurality of dielectric layers and a plurality of internal electrodes disposed alternately in the first direction; and
an external electrode disposed the third or fourth surfaces,
wherein, when a maximum size of the multilayer electronic component in the first direction is denoted by T, a maximum size of the multilayer electronic component in the second direction is denoted by L, and a maximum size of the multilayer electronic component in the third direction is denoted by W, W>L and 1.25≤T/L≤1.5 are satisfied.

2. The multilayer electronic component of claim 1, wherein T and L satisfy 1.3≤T/L≤1.4.

3. The multilayer electronic component of claim 1, wherein L and W satisfy L/W≤0.8.

4. The multilayer electronic component of claim 1, wherein L and W satisfy L≥2.5 mm and W≥3.2 mm.

5. The multilayer electronic component of claim 1, wherein a ratio of a maximum size of the internal electrode in the third direction to W is 0.7 or more and 0.9 or less.

6. The multilayer electronic component of claim 1, wherein an average thickness of the internal electrode is 1.0 μm or more.

7. The multilayer electronic component of claim 1, wherein
the plurality of internal electrodes includes a first internal electrode exposed to the third surface and a second internal electrode exposed to the fourth surface, and the first and second internal electrodes are disposed with a corresponding dielectric layer in the plurality of dielectric layers interposed therebetween, and
the body further includes a first dummy electrode spaced apart from the second internal electrode in the second direction and exposed to the third surface, and a second dummy electrode spaced apart from the first internal electrode in the second direction and exposed to the fourth surface.

8. The multilayer electronic component of claim 1, wherein
the plurality of internal electrodes includes a first internal electrode group and a second internal electrode group disposed with a corresponding dielectric layer in the plurality of dielectric layers interposed therebetween,
the first internal electrode group includes a first internal electrode exposed to the third surface, and a second internal electrode spaced apart from the first internal electrode in the second direction and exposed to the fourth surface,
the second internal electrode group includes a third internal electrode spaced apart from the third and fourth surfaces, and
the third internal electrode overlaps a portion of the first internal electrode and a portion of the second internal electrode in the first direction.

9. The multilayer electronic component of claim 1, wherein
the plurality of internal electrodes includes a first internal electrode group and a second internal electrode group disposed with a corresponding dielectric layer in the plurality of dielectric layers interposed therebetween,
the first internal electrode group includes a first internal electrode exposed to the third surface, a second internal electrode spaced apart from the first internal electrode in the second direction and exposed to the fourth surface, and a third internal electrode disposed between the first and second internal electrodes,
the second internal electrode group includes fourth and fifth internal electrodes spaced apart from the third and fourth surfaces, the fourth and fifth internal electrodes spaced apart from each other in the second direction,
the fourth internal electrode overlaps a portion of the first internal electrode and a portion of the third internal electrode in the first direction, and
the fifth internal electrode overlaps a portion of the second internal electrode and a portion of the third internal electrode in the first direction.

10. The multilayer electronic component of claim 1, wherein the dielectric layer includes (Ca₁₋ₓSrₓ)(Zr_{1-y}Ti_{y})O₃, wherein 0≤x≤0.5, 0≤y≤0.5.

11. The multilayer electronic component of claim 1, wherein the multilayer electronic component has a capacitance of 10 nF or more.

12. The multilayer electronic component of claim 1, wherein
the plurality of internal electrodes includes a plurality of first internal electrodes exposed to the third surface and a plurality of second internal electrodes exposed to the fourth surface, and
a respective first internal electrode in the plurality of first internal electrodes and a respective second internal electrode in the plurality of second internal electrodes are disposed with a corresponding dielectric layer in the plurality of dielectric layers interposed therebetween.
